(19) United States
(12) Patent Application Publication
(10) Pub. No.: US 2022/0385785 A1
(43) Pub. Date: Dec. 1, 2022

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Shingo KATO, Kanagawa (JP)

(73) Assignee: FUJIFILM Business Innovation Corp., Tokyo (JP)

(21) Appl. No.: 17/527,185

(22) Filed: Nov. 16, 2021

(30) Foreign Application Priority Data
May 26, 2021 (JP) 2021-088621

(51) Int. Cl. H04N 1/32; H04N 1/00; G06K 9/00

(52) U.S. Cl. CPC H04N 1/32374; H04N 1/00411; G06K 9/00449; G06K 2209/01

(57) ABSTRACT

An information processing apparatus includes a processor configured to, in a case where a first device capable of using a specific service succeeds in authenticating a user, and input data input by a function of the specific service selected by the user is present in a second device capable of using the specific service, display a screen provided in a case where the function is selected, without receiving the selection of the function by the user.

### CROSS-REFERENCE TO RELATED APPLICATIONS

This application is based on and claims priority under 35 USC 119 from Japanese Patent Application No. 2021-088621 filed May 26, 2021.

### BACKGROUND

### (i) Technical Field

The present invention relates to an information processing apparatus, a non-temporary computer readable medium storing an information processing program, and an information processing method.

### (ii) Related Art

JP2006-303805A discloses an image processing system capable of executing an intended process with an easy operation.

### SUMMARY

In recent years, the functions of cloud services in various fields have been published as APIs, and thus the cloud services can be used by a plurality of devices through the APIs.

Here, a user succeeds in authenticating the cloud service, and then selects an intended function, thereby the user causes the authenticated device to execute a process by the selected function.

As an example of the process by the above-selected function, a user may input data in one device, and then attach voucher data indicating a voucher of the data input in the other device. In this case, it is necessary to select the function selected in one device, in the other device. As a result, it is necessary to select a function common for both one device and the other device, and thus a work is complicated.

Aspects of non-limiting embodiments of the present disclosure relate to an information processing apparatus, a non-temporary computer readable medium storing an information processing program, and an information processing method for omitting a selection of a function of a service in one device in a case where the function of the service is selected in the other device, and input data is input, in a service available in the one device and the other device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

An information processing apparatus includes a processor configured to, in a case where a first device capable of using a specific service succeeds in authenticating a user, and input data input by a function of the specific service selected by the user is present in a second device capable of using the specific service, display a screen provided in a case where the function is selected, without receiving the selection of the function by the user.

### BRIEF DESCRIPTION OF THE DRAWINGS

Exemplary embodiment(s) of the present invention will be described in detail based on the following figures, wherein:

FIG. 1 is a schematic diagram illustrating a configuration of an information processing system;

FIG. 2 is a block diagram illustrating a hardware configuration of an image forming apparatus;

FIG. 3 is a block diagram illustrating a hardware configuration of a cloud server and a user terminal;

FIGS. 4A to 4C illustrate display examples of a display unit of the user terminal;

FIGS. 5A to 5C illustrate display examples of a display unit of an image forming apparatus in a configuration in the related art;

FIG. 6 is a first flowchart illustrating a flow of a determination process;

FIGS. 7A and 7B illustrate first display examples of the display unit of the image forming apparatus in the information processing system;

FIG. 8 illustrates a second display example of the display unit of the image forming apparatus in the information processing system;

FIG. 9 is a second flowchart illustrating the flow of the determination process;

FIGS. 10A to 10C illustrate third display examples of the display unit of the image forming apparatus in the information processing system; and

FIG. 11 illustrates a fourth display example of the display unit of the image forming apparatus in the information processing system.

### DETAILED DESCRIPTION

First Exemplary Embodiment

Hereinafter, an information processing system 10 according to a first exemplary embodiment will be described.

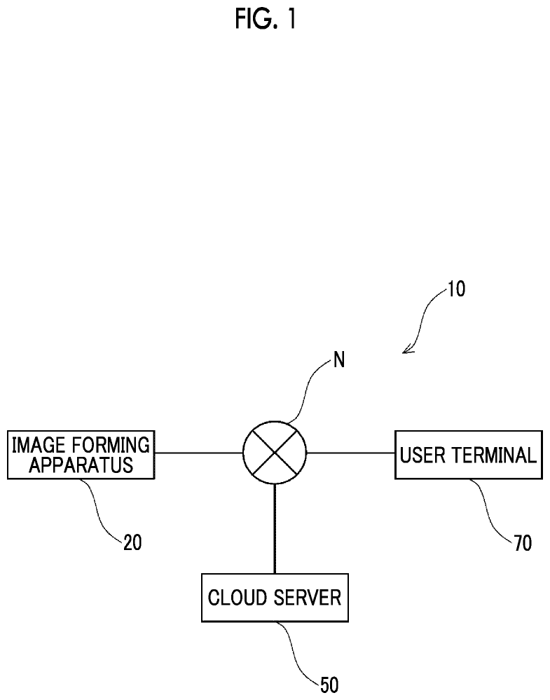

FIG. 1 is a schematic diagram illustrating a configuration of an information processing system 10.

As illustrated in FIG. 1, the information processing system 10 includes an image forming apparatus 20, a cloud server 50, and a user terminal 70. The image forming apparatus 20, the cloud server 50, and the user terminal 70 are connected to each other via a network N to be communicable with each other. As an example, the Internet, a local area network (LAN), and a wide area network (WAN) are applied as the network N. The image forming apparatus 20 is an example of an “information processing apparatus” and a “first device”. The user terminal 70 is an example of a “second device”.

In the information processing system 10, in a case where a plurality of devices including the image forming apparatus 20 and the user terminal 70 use a cloud service, a display content of a screen at time of using the cloud service in the image forming apparatus 20 is changed in accordance with whether or not there is edited data obtained in a manner that editing is performed by an application of the cloud service, which is selected by a user in the user terminal 70. The cloud server 50 is a server computer that provides a cloud service in the information processing system 10. The cloud service is an example of a “specific service”. The application is an example of a “function”. The edited data is an example of “input data”.

The cloud service provides services related to forms being records used as evidence such as “quotations”, “invoices”, “order documents”, “delivery notes”, and “receipts”. As an example, the user may use the cloud service to attach voucher data to the edited data of a form, which is obtained by editing in the user terminal 70. The voucher data indicates the voucher of the edited data by a scanning function of the image forming apparatus 20. The voucher data refers to a document for verifying that a transaction has been completed. Examples of the voucher data include data related to documents necessary for expense recording and filing such as receipts and invoices, and data related to delivery notes and contract documents. The voucher data indicating the voucher of the edited data is an example of “relevant data related to the input data”. The exemplary embodiment is not limited to the voucher data, and any data may be provided so long as the data relates to the edited data.

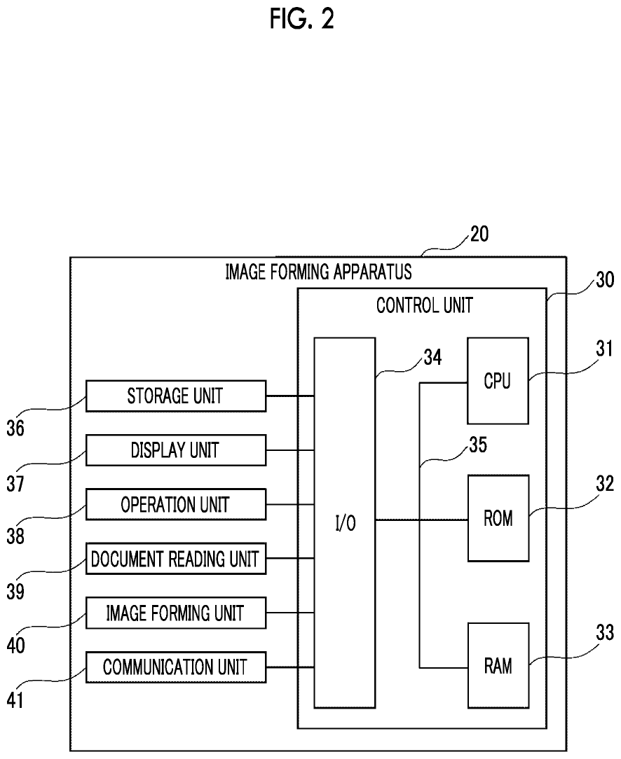

FIG. 2 is a block diagram illustrating a hardware configuration of the image forming apparatus 20.

As illustrated in FIG. 2, the image forming apparatus 20 includes a control unit 30 that controls the operation of the image forming apparatus 20. In the control unit 30, a central processing unit (CPU) 31, a read only memory (ROM) 32, a random access memory (RAM) 33, and an input/output interface (I/O) 34 are connected to each other via a bus 35 to be communicable with each other. The CPU 31 is an example of a “processor”.

The CPU 31 is a central arithmetic processing unit that executes various programs and controls the units. That is, the CPU 31 reads the program from the ROM 32 or a storage unit 36 described later, and executes the program using the RAM 33 as a work area. The CPU 31 controls the above components and executes various arithmetic processes, in accordance with the programs recorded in the ROM 32 or the storage unit 36. In the first exemplary embodiment, at least an information processing program for executing a determination process described later is stored in the ROM 32 or the storage unit 36. The information processing program may be installed on the image forming apparatus 20 in advance, or may be appropriately installed on the image forming apparatus 20 by being stored in a non-volatile storage medium or distributed via the network N. As an example of the non-volatile storage medium, a CD-ROM, a magneto-optical disk, a hard disk drive (HDD), a DVD-ROM, a flash memory, a memory card, and the like are assumed.

The ROM 32 stores various programs and various types of data. The RAM 33 temporarily stores the program or the data as a work area.

The storage unit 36, a display unit 37, an operation unit 38, a document reading unit 39, an image forming unit 40, and a communication unit 41 are connected to the I/O 34. Each of the above units may communicate with the CPU 31 via the I/O 34.

The storage unit 36 is configured by a storage device such as an HDD, a solid state drive (SSD) , or a flash memory, and stores various programs and various types of data.

As the display unit 37, for example, a liquid crystal display (LCD) or an organic electroluminescence (EL) display or the like is used. The display unit 37 may integrally include a touch panel.

Various operation keys such as a numeric keypad and a start key are provided in the operation unit 38.

The display unit 37 and the operation unit 38 receive various instructions from a user of the image forming apparatus 20. The various instructions include, for example, an instruction to start reading of a document such as a form, and an instruction to start copying of the document. The display unit 37 displays various types of information such as the result of a process executed in accordance with the instruction received from the user and the notification in response to the process.

The document reading unit 39 takes documents placed on a paper feed tray of an automatic document feeder (not illustrated) provided on the upper portion of the image forming apparatus 20 one by one, and optically reads the taken document to obtain image information. Alternatively, the document reading unit 39 optically reads a document placed on a document stand such as platen glass to obtain image information.

The image forming unit 40 forms, on a recording medium such as paper, an image based on image information obtained by reading of the document reading unit 39 or image information obtained from an external personal computer (PC) connected via the network N.

The communication unit 41 is an interface for communicating with other devices such as a PC. For the communication, for example, the standard of a wired communication such as Ethernet (registered trademark) or FDDI, or the standard of a wireless communication such as 4G, 5G, or Wi-Fi (registered trademark) is used.

In a case of executing the above information processing program, the image forming apparatus 20 executes the process based on the information processing program by using the above hardware resources.

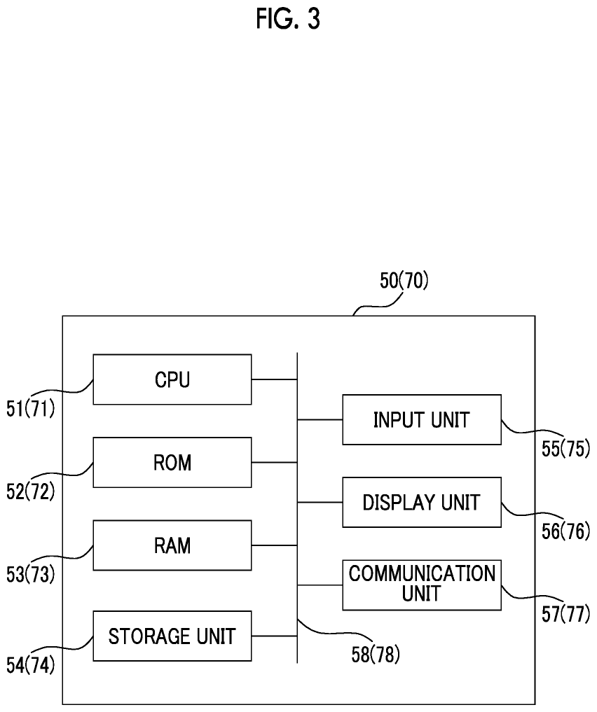

FIG. 3 is a block diagram illustrating a hardware configuration of the cloud server 50 and the user terminal 70. As an example, a server computer, a general-purpose computer device such as a PC, or a mobile terminal such as a smartphone or a tablet terminal is applied as the cloud server 50 and the user terminal 70. In the first exemplary embodiment, the cloud server 50 is set to a “server computer”, and the user terminal 70 is set to a “PC”. The cloud server 50 and the user terminal 70 basically have a general computer configuration, and thus the cloud server 50 will be described as a representative.

As illustrated in FIG. 3, the cloud server 50 includes a CPU 51, a ROM 52, a RAM 53, a storage unit 54, an input unit 55, a display unit 56, and a communication unit 57. The components are connected to each other via a bus 58 to be communicable with each other.

The CPU 51 is a central arithmetic processing unit that executes various programs and controls the units. That is, the CPU 51 reads the program from the ROM 52 or the storage unit 54, and executes the program using the RAM 53 as a work area. The CPU 51 controls the above components and executes various arithmetic processes, in accordance with the programs stored in the ROM 52 or the storage unit 54.

The ROM 52 stores various programs and various types of data. The RAM 53 temporarily stores the program or the data as a work area.

The storage unit 54 is configured by a storage device such as an HDD, an SSD, or a flash memory, and stores various programs including an operating system and various types of data.

As an example, the input unit 55 includes a pointing device such as a mouse, various buttons, a keyboard, a microphone, a camera, and the like, and is used for performing various inputs.

The display unit 56 is, for example, a liquid crystal display and displays various types of information. The display unit 56 may adopt a touch panel type and function as the input unit 55.

The communication unit 57 is an interface for communicating with other devices. For the communication, for example, the standard of a wired communication such as Ethernet (registered trademark) or FDDI, or the standard of a wireless communication such as 4G, 5G, or Wi-Fi (registered trademark) is used.

Next, the display contents of a screen in a configuration (referred to as a “configuration in the related art” below) in which the information processing system 10 is not used in using the cloud service will be described.

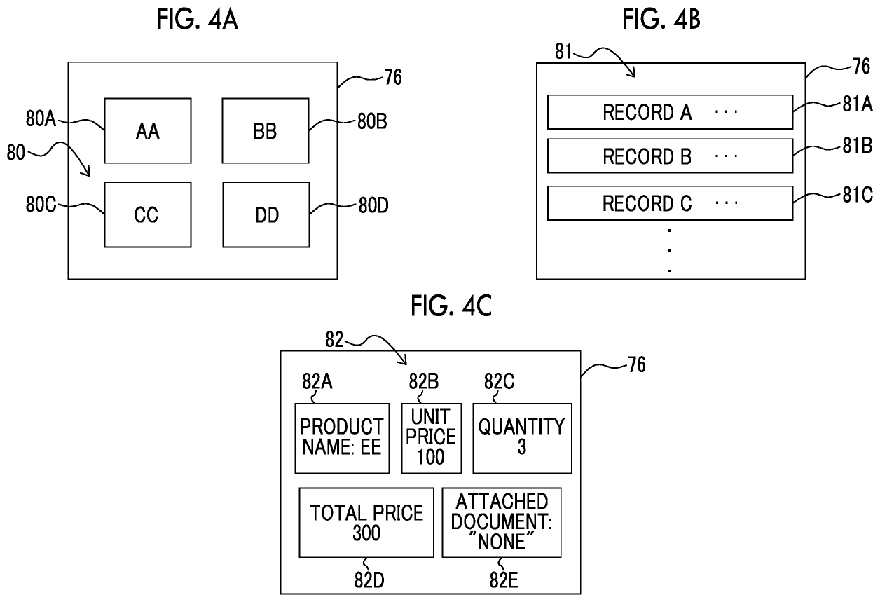

FIGS. 4A to 4C illustrates display examples of a display unit 76 of the user terminal 70. Specifically, FIG. 4A illustrates a display example of an application selection screen 80 displayed after authentication of a user who has succeeded in authenticating of a cloud service in the user terminal 70, specifically, immediately after the authentication. FIG. 4B illustrates a display example of a record selection screen 81 which has transitioned from the application selection screen 80. FIG. 4C illustrates a display example of an edit screen 82 which has transitioned from the record selection screen 81.

The application selection screen 80 illustrated in FIG. 4A is a screen for receiving a selection of an intended application by the user from a plurality of applications provided by the cloud service. On the application selection screen 80, as an example, an icon 80A corresponding to an application AA, an icon 80B corresponding to an application BB, an icon 80C corresponding to an application CC, and an icon 80D corresponding to an application DD are displayed. In a case where any of the icons displayed on the application selection screen 80 is selected, the application corresponding to the selected icon is executed and then the record selection screen 81 is displayed.

The record selection screen 81 illustrated in FIG. 4B is a screen for displaying one or a plurality of records corresponding to the application selected on the application selection screen 80 and receiving a selection of an intended record by the user. As an example, FIG. 4B illustrates the record selection screen 81 in a case where the icon 80A has been selected on the application selection screen 80. A plurality of records of the application AA corresponding to the icon 80A are displayed.

Here, although some illustrations are omitted in FIG. 4B, the above records include a plurality of items such as “record name”, “product name”, “unit price”, “quantity”, and “total price”, and “attached document”, as an example. The items are not limited to the above types, and other types may be provided.

The item “record name” is an item for inputting identification information for uniquely identifying each record.

The item “product name” is an item for inputting the name of each product.

The item “unit price” is an item for inputting the unit price of the product input in the item “product name”.

The item “quantity” is an item for inputting the quantity of the product input in the item “product name”.

The item “total price” is an item for inputting the total price of the products input in the item “product name”.

The item “attached document” is an item to which voucher data indicating the voucher of the edited data of the record including the data input in the items “product name”, “unit price”, “quantity”, “total price” and the like is attached.

Further, on the record selection screen 81 illustrated in FIG. 4B, as an example, a record 81A corresponding to “record name: record A”, a record 81B corresponding to “record name: record B”, and a “record name: record C” are displayed. A plurality of records such as record 81C corresponding to “record C” are displayed. Then, in a case where any of the records displayed on the record selection screen 81 is selected, the edit screen 82 corresponding to the selected record is displayed.

The edit screen 82 illustrated in FIG. 4C is a screen for receiving editing of edited data of the record selected on the record selection screen 81. As an example, FIG. 4C illustrates an edit screen 82 in a case where the record 81A is selected on the record selection screen 81.

Here, on the edit screen 82 illustrated in FIG. 4C, a reception portion 82A for receiving an input of data in the item “product name”, a reception portion 82B for receiving an input of data in the item “unit price”, a reception portion 82C for receiving an input of data in the item “quantity”, a reception portion 82D for receiving an input of data in the item “total price”, and a reception portion 82E for receiving an input of data in the item “attached document” are provided.

The reception portion 82A is a portion in which the product name is input as the above data, and “EE” is input in FIG. 4C.

The reception portion 82B is a portion in which the unit price of the product is input as the above data, and “100” is input in FIG. 4C.

The reception portion 82C is a portion in which the quantity of the product is input as the above data, and “3” is input in FIG. 4C.

The reception portion 82D is a portion in which the total price of the products is input as the above data, and “300” is input in FIG. 4C.

The reception portion 82E is a portion for receiving an attachment of voucher data indicating a voucher of edited data of a record including pieces of data input in the reception portions 82A to 82D. In FIG. 4C, “attached document “none”” is displayed at the reception portion 82E and it indicates that the voucher data is not attached.

As described above, the edit screen 82 illustrated in

FIG. 4C shows that data is input to the items “product name”, “unit price”, “quantity”, and “total price” in “record name: record A”, and edited data of a record in which voucher data is not attached is shown in the item “attached document”. In the cloud service, the edited data of the record on the edit screen 82 is stored as record information.

Here, as an example of a method of attaching voucher data to a record, a method of attaching voucher data already stored in the user terminal 70 on the edit screen 82 and a method of reading a form as a voucher document by the scanning function of the image forming apparatus 20 and attaching the voucher data are assumed. Then, a case where the latter method of reading the voucher document by the scanning function of the image forming apparatus 20 and attaching the voucher data will be described below.

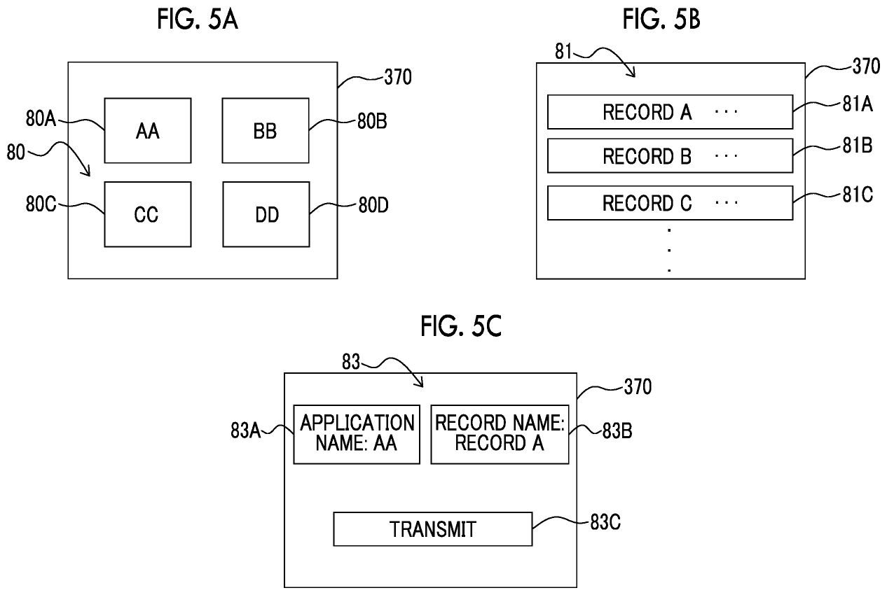

FIGS. 5A to 5C illustrate display examples of a display unit 370 of an image forming apparatus in a configuration in the related art. Specifically, FIG. 5A illustrates a display example of an application selection screen 80 displayed immediately after authentication of the cloud service by a user with an image forming apparatus. FIG. 5B illustrates a display example of a record selection screen 81 which has transitioned from the application selection screen 80. FIG. 5C illustrates a display example of a transmission screen 83 which has transitioned from the record selection screen 81.

The application selection screen 80 illustrated in FIG. 5A has display contents similar to display contents of the application selection screen 80 illustrated in FIG. 4A, and is a screen for receiving a selection of an application to which voucher data is attached, by the user with the image forming apparatus. In a case where any of the icons displayed on the application selection screen 80 is selected, the application corresponding to the selected icon is executed and then the record selection screen 81 is displayed.

The record selection screen 81 illustrated in FIG. 5B has display contents similar to display contents of the record selection screen 81 illustrated in FIG. 4B and is a screen for receiving a selection of a record in which voucher data is attached, by the user with the image forming apparatus. As an example, FIG. 5B illustrates the record selection screen 81 in a case where the icon 80A has been selected on the application selection screen 80. A plurality of records of the application AA corresponding to the icon 80A are displayed. Then, in a case where any of the records displayed on the record selection screen 81 is selected, the transmission screen 83 corresponding to the selected record is displayed.

The transmission screen 83 illustrated in FIG. 5C is a screen for enabling transmission of voucher data to the cloud service. As an example, on the transmission screen 83, an application name display 83A indicating the application name selected on the application selection screen 80, a record name display 83B indicating the record name selected on the record selection screen 81, and a transmission button 83C for starting a transmission process of voucher data are displayed. As an example, FIG. 5C illustrates the transmission screen 83 in a case where an icon 80A is selected on the application selection screen 80 and a record 81A is selected on the record selection screen 81.

Here, as a flow of a series of works after editing of the edited data in a record by the user terminal 70, a voucher document may be read by the scanning function of the image forming apparatus and the voucher data may be attached to the edited data. In this case, the following problems occur in the configuration in the related art. In the configuration in the related art, as described above, the application selection screen 80 and the record selection screen 81 are displayed on both the user terminal 70 and the image forming apparatus, and the common application and record are selected on both the user terminal 70 and the image forming apparatus. Thus, the work becomes complicated.

Therefore, in the first exemplary embodiment, an object is to omit selection of an application in the image forming apparatus 20 in a case where the application of the cloud service is selected in the user terminal 70 and the edited data is edited.

Here, in the information processing system 10 according to the first exemplary embodiment, information is transmitted from the cloud service to the cloud server 50 by using a webhook that transmits information to a uniform resource locator (URL) designated in a case where a predetermined event occurs. In the first exemplary embodiment, the above predetermined event is referred to as “display of the edit screen 82”. That is, regardless of whether or not the edited data in the record has been edited on the edit screen 82, a case where the edit screen is displayed means the above “occurrence of the predetermined event”, and the information (referred to as “cloud service information” below) is transmitted to the cloud server 50 from the cloud service. The cloud service information includes at least the application name and the record name of the cloud service in which the predetermined event has occurred. The cloud server 50 associates the acquired cloud service information with user information (example: user ID in authentication) of the user who causes the predetermined event and stores the resultant of the association in the storage unit 54.

In the first exemplary embodiment, by using the webhook, it is possible to transmit information regarding a predetermined event intended by the user, from the cloud service to the cloud server 50.

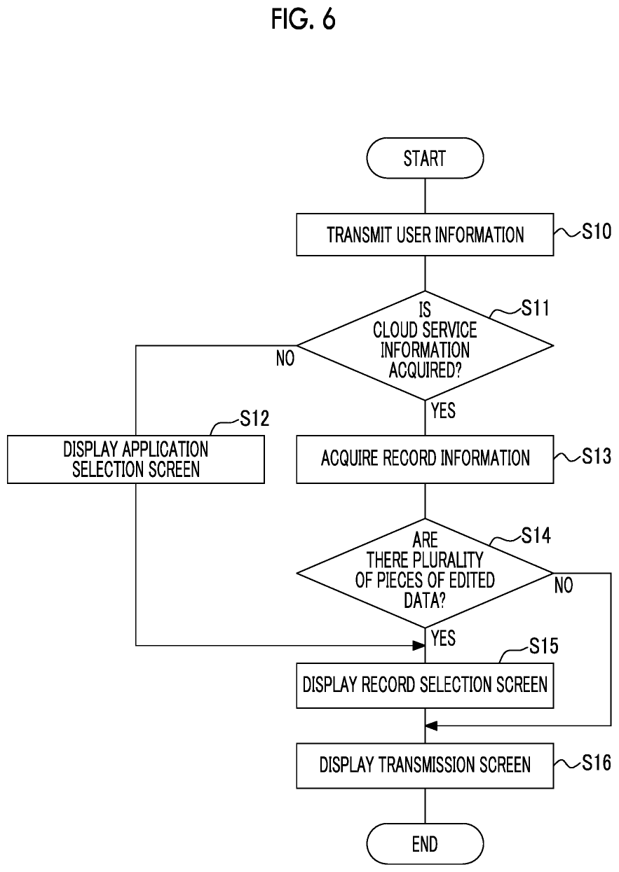

FIG. 6 is a first flowchart illustrating a flow of a determination process of determining a screen displayed on the display unit 37 in the image forming apparatus 20. The CPU 31 reads the information processing program from the ROM 32 or the storage unit 36, and loads and executes the information processing program on the RAM 33 to execute the determination process.

In Step S10 illustrated in FIG. 6, in a case where a user succeeds in authenticating the image forming apparatus 20, the CPU 31 transmits user information (example: user ID in authentication) of the user to the cloud server 50. Then, the process proceeds to Step S11. In the first exemplary embodiment, as an example, the authentication of the image forming apparatus 20 is performed by using an IC card associated with information of a portal site determined in advance.

In Step S11, in a case where the CPU 31 acquires cloud service information associated with the user information transmitted in Step S10 (Step S11: YES) , the process proceeds to Step S13. In a case where the CPU 31 does not acquire the cloud service information associated with the user information (Step S11: NO), the process proceeds to Step S12.

In the first exemplary embodiment, the cloud server 50 that has acquired the user information transmitted from the image forming apparatus 20 in Step S10 searches for the cloud service information associated with the user information, in the storage unit 54, and then transmits a search result as a response to the image forming apparatus 20. In a case where the cloud service information is stored in the storage unit 54, the cloud server 50 transmits the cloud service information (example: application name and record name) to the image forming apparatus 20 as the above response. In this case, since the CPU 31 acquires cloud service information in Step S11, the process proceeds to Step 513. Ina case where the cloud service information is not stored in the storage unit 54, the cloud server 50 transmits information indicating that there is no cloud service information, as the above response, to the image forming apparatus 20. In this case, since the CPU 31 does not acquire the cloud service information in Step S11, the process proceeds to Step S12.

In Step S12, the CPU 31 causes the display unit 37 to display the application selection screen 80. Then, the process proceeds to Step S15.

In Step S13, the CPU 31 acquires record information from the cloud service by using the cloud service information (example: application name and record name) acquired in Step S11. Then, the process proceeds to Step S14. Here, the CPU 31 acquires the latest edited data of a record corresponding to the cloud service information from the cloud service as the record information.

In Step S14, the CPU 31 determines whether or not there are a plurality of pieces of edited data from the record information acquired in Step S13. In a case where it is determined that there are the plurality of pieces of edited data (Step S14: YES), the process proceeds to Step S15. In a case where the CPU 31 determines that the plurality of pieces of edited data are not provided (Step S14: NO), the process proceeds to Step S16.

In Step S15, the CPU 31 causes the display unit 37 to display the record selection screen 81. Then, the process proceeds to Step S16.

In Step S16, the CPU 31 causes the display unit 37 to display the transmission screen 83. Then, the process is ended.

Next, the display contents of the screen in the information processing system 10 will be described. The display contents of the user terminal 70 in the information processing system 10 are similar to display contents of the display example illustrated in FIGS. 4A to 4C described above. That is, the display unit 76 of the user terminal 70 in the information processing system 10 transitions the screen in the order of the application selection screen 80, the record selection screen 81, and the edit screen 82. Display examples of the display unit 37 in the image forming apparatus 20 in a case where the user terminal 70 is operated in advance by the user and there are one or a plurality of pieces of edited data will be described.

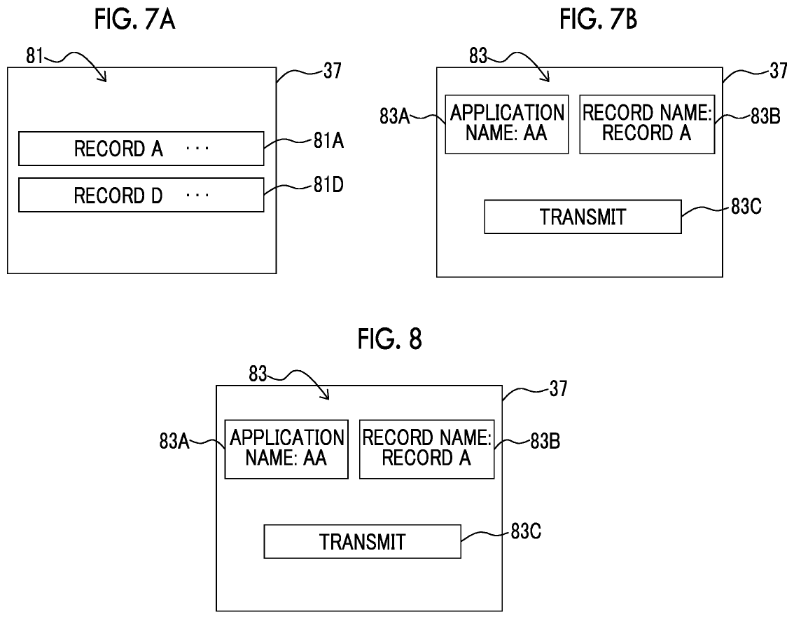

FIGS. 7A and 7B illustrate first display examples of the display unit 37 of the image forming apparatus 20. Specifically, FIG. 7A illustrates a display example of the record selection screen 81 displayed after the authentication of the image forming apparatus 20 of the user, and specifically, immediately after the authentication, in a case where there are a plurality of pieces of edited data. FIG. 7B illustrates a display example of the transmission screen 83 that has transitioned from the record selection screen 81. As described above, in a case where there are the plurality of pieces of edited data, the CPU 31 does not receive the selection of the application of the cloud service on the image forming apparatus 20 by the user, and displays the record selection screen 81 as a screen in a case where the application is selected, immediately after the authentication of the image forming apparatus 20. That is, in this case, differing from the configuration in the related art illustrated in FIGS. 5A to 5C, the display of the application selection screen 80 on the image forming apparatus 20 is omitted.

Differing from the record selection screen 81 illustrated in FIG. 5B, the record selection screen 81 illustrated in FIG. 7A displays only records having the edited data.

The transmission screen 83 illustrated in FIG. 7B has a display content similar to the display content of the transmission screen 83 illustrated in FIG. 5C, and is a screen for enabling transmission of voucher data to the cloud service. As an example, FIG. 7B illustrates the transmission screen 83 in a case where the record 81A is selected on the record selection screen 81.

FIG. 8 illustrates a second display example of the display unit 37 of the image forming apparatus 20. Specifically, FIG. 8 illustrates a display example of the transmission screen 83 displayed after the authentication of the image forming apparatus 20 of the user, specifically, immediately after the authentication, in a case where there is one piece of edited data. As described above, in a case where there is the one piece of edited data, the CPU 31 does not receive the selection of the application of the cloud service and the record on the image forming apparatus 20 by the user, and displays the transmission screen 83 as a screen in a case where the application is selected, immediately after the authentication of the image forming apparatus 20. That is, in this case, differing from the configuration in the related art illustrated in FIGS. 5A to 5C, the display of the application selection screen 80 and the record selection screen 81 on the image forming apparatus 20 is omitted.

The transmission screen 83 illustrated in FIG. 8 has a display content similar to the display content of the transmission screen 83 illustrated in FIG. 5C, and is a screen for enabling transmission of voucher data to the cloud service.

By using the latest edited data included in the record information acquired in Step S13 illustrated in FIG. 6, the transmission screen 83 illustrated in FIG. 8 turns into a state where the selection of the application of the cloud service and the record on the image forming apparatus 20 by the user is not received, and the application and the record corresponding to the edited data are input as a transmission destination of voucher data.

As described above, in the first exemplary embodiment, in a case where the user has succeeded in authenticated by the image forming apparatus 20 that can use the cloud service, and edited data obtained by performing editing by the application of the cloud service selected by the user is present in the user terminal 70 that can use the cloud service, the CPU 31 displays the screen provided in a case where the application is selected, without receiving the selection of the application by the user. Therefore, according to the first exemplary embodiment, in a case where the application of the cloud service is selected on the user terminal 70 and the edited data is edited, it is possible to omit selection of the application on the image forming apparatus 20. The CPU 31 displays the screen in a case where the application is selected, after the authentication of the image forming apparatus 20 of the user, specifically, immediately after the authentication. Therefore, according to the first exemplary embodiment, the user is caused to recognize the screen in a case where the application is selected, immediately after the authentication of the image forming apparatus 20.

Further, in the first exemplary embodiment, as described above with reference to FIGS. 7A to 8, the CPU 31 changes the screen to be displayed immediately after the authentication of the image forming apparatus 20 of the user, in accordance with the number of pieces of edited data being present. Therefore, according to the first exemplary embodiment, it is possible to increase the number of types of screens to be displayed immediately after the authentication of the image forming apparatus 20 of the user, in comparison to a configuration in which the identical screen is displayed immediately after the authentication of the image forming apparatus 20 of the user.

Further, in the first exemplary embodiment, as described above with reference to FIGS. 7A and 7B, in a case where there are a plurality of pieces of edited data, the CPU 31 displays the record selection screen 81 for selecting the edited data to which the voucher data is attached, immediately after the authentication of the image forming apparatus 20 of the user, and displays the transmission screen 83 for enabling transmission of voucher data to the cloud service, after the edited data is selected on the record selection screen 81. Therefore, according to the first exemplary embodiment, it is possible to display the transmission screen 83 after the record selection screen 81 is displayed, by omitting the application selection screen 80. The record selection screen 81 is an example of a “selection screen”.

Further, in the first exemplary embodiment, as described above with reference to FIG. 8, in a case where there is one piece of edited data, the CPU 31 displays the transmission screen 83 for enabling transmission of voucher data to the cloud service, immediately after the authentication of the image forming apparatus 20 of the user. Therefore, according to the first exemplary embodiment, it is possible to display the transmission screen 83 by omitting the application selection screen 80 and the record selection screen 81. Thus, according to the first exemplary embodiment, in a case where the scan setting including color setting and resolution setting is completed in advance, or in a case where the scan setting is unnecessary, the transmission process of voucher data is started only by operating the transmission button 83C immediately after the authentication of the image forming apparatus 20 of the user.

Here, in the first exemplary embodiment, in a case where the voucher data is transmitted to the cloud service, the CPU 31 changes the display content of the screen in accordance with a processing time taken to execute the transmission process of the voucher data. Therefore, according to the first exemplary embodiment, it is possible to increase the number of types of screens to be displayed in a case where the voucher data is transmitted to the cloud service, in comparison to a configuration in which the identical screen is displayed in a case where the voucher data is transmitted to the cloud service.

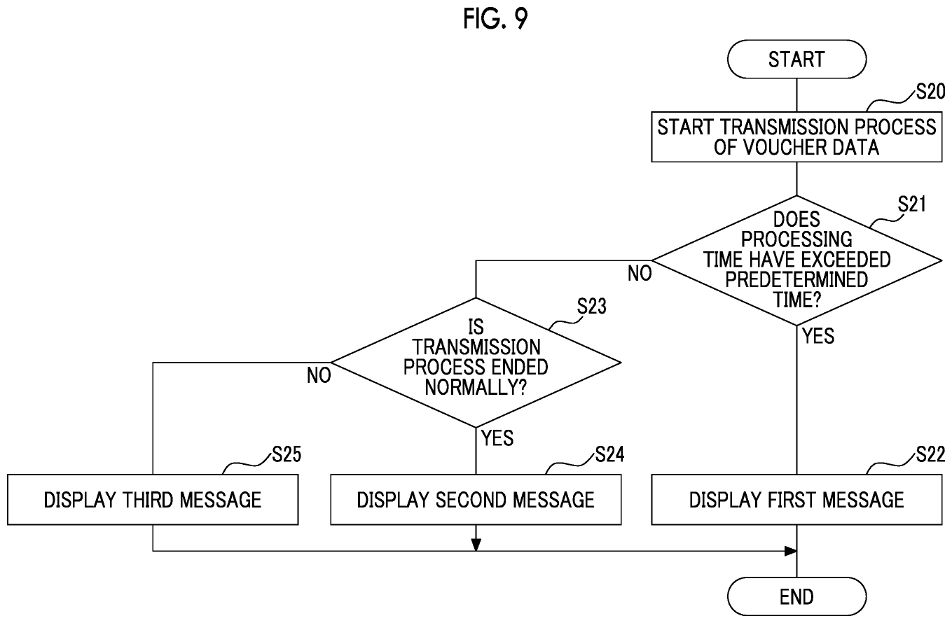

FIG. 9 is a second flowchart illustrating a flow of a determination process of determining a screen displayed on the display unit 37 in the image forming apparatus 20.

In Step S20 illustrated in FIG. 9, the CPU 31 starts the transmission process of voucher data. Then, the process proceeds to Step S21. In the first exemplary embodiment, as an example, in a case where the transmission button 83C is operated on the transmission screen 83, the CPU 31 starts the transmission process of the voucher data.

In Step S21, the CPU 31 determines whether or not the processing time taken to execute the transmission process exceeds a predetermined time. In a case where it is determined that the processing time has exceeded the predetermined time (Step S21: YES), the process proceeds to Step S22. In a case where the CPU 31 determines that the processing time does not have exceeded the predetermined time (Step S21: NO), the process proceeds to Step S23. In the first exemplary embodiment, as an example, the predetermined time is set to “one minute”. In Step S21, the CPU 31 requests the cloud server 50 to confirm the result of the transmission process. In a case where a response to the result confirmation from the cloud server 50 does not exceed the predetermined time, the CPU 31 determines that “the processing time has exceeded the predetermined time”.

In Step S22, the CPU 31 causes the display unit 37 to display a first message. Then, the process is ended. The details of the first message will be described later.

In Step S23, the CPU 31 determines whether or not the transmission process has ended normally. In a case where it is determined that the transmission process has ended normally (Step S23: YES), the process proceeds to Step S24. In a case where the CPU 31 determines that the transmission process has not ended normally, that is, the transmission process has ended due to an occurrence of an abnormality (Step S23: NO), the process proceeds to Step S25. As an example, in a case where the response to the result confirmation of the transmission process from the cloud server 50 has a content for informing a normal end, the CPU 31 determines that “the transmission process has ended normally”. In addition, in a case where the response to the result confirmation from the cloud server 50 has a content for informing an abnormal end, the CPU 31 determines that “the transmission process does not have ended normally”.

In Step S24, the CPU 31 causes the display unit 37 to display a second message. Then, the process is ended. The details of the second message will be described later.

In Step S25, the CPU 31 causes the display unit 37 to display a third message. Then, the process is ended. The details of the third message will be described later.

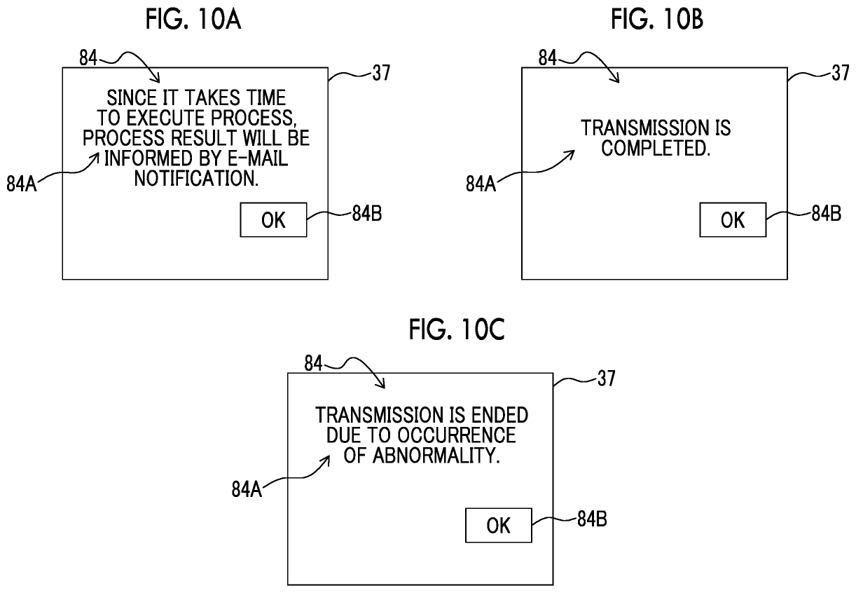

FIGS. 10A to 10C illustrates third display examples of the display unit 37 of the image forming apparatus 20. Specifically, FIGS. 10A to 10C illustrates a result screen 84 for displaying the result of the transmission process. FIG. 10A illustrates a display example in a case where the first message is displayed on the result screen 84. FIG. 10B illustrates a display example in a case where the second message is displayed on the result screen 84. FIG. 10C illustrates a display example in a case where the third message is displayed on the result screen 84.

As an example, a message display 84A indicating a message for the user and an OK button 84B are displayed on the result screen 84 illustrated in FIGS. 10A to 10C. In a case where the OK button 84B is operated while the result screen 84 is being displayed, the CPU 31 changes the screen of the display unit 37 to a predetermined display content.

In the message display 84A illustrated in FIG. 10A, as an example of the first message, the text “since it takes time to execute the process, the process result will be informed by an e-mail notification” is displayed. As described above, in the first exemplary embodiment, in a case where the transmission process is not ended even though the processing time taken to execute the transmission process exceeds the predetermined time, the CPU 31 causes the display unit 37 to display information indicating that the process result is presented after the end of the transmission process, as the first message. Therefore, according to the first exemplary embodiment, the user is caused to recognize that the process result is presented after the end of the transmission process. Further, according to the first exemplary embodiment, in a case where the transmission process is not ended even though the processing time exceeds the predetermined time, it is possible to urge the movement of the user by displaying the first message. Thus, it is expected that occupancy of the image forming apparatus 20 by one user for a long time is suppressed. After the end of the transmission process, the cloud server 50 transmits information indicating that the transmission process is normally ended or information indicating that the transmission process is ended due to the occurrence of an abnormality, to the user terminal 70 of a user who has started the transmission process on the image forming apparatus 20, as the above process result.

In the message display 84A illustrated in FIG. 10B, the text “transmission is completed” is displayed as an example of the second message. As described above, in the first exemplary embodiment, in a case where the processing time taken to execute the transmission process does not exceed the predetermined time, and the transmission process is normally ended, the CPU 31 causes the display unit 37 to display the information indicating that the transmission process is normally ended, as the second message. Therefore, according to the first exemplary embodiment, the user is caused to recognize that the transmission process has been normally ended.

In the message display 84A illustrated in FIG. 10C, the text “transmission is ended due to the occurrence of an abnormality” is displayed as an example of the third message. As described above, in the first exemplary embodiment, in a case where the processing time taken to execute the transmission process does not exceed the predetermined time, and the transmission process is ended due to the occurrence of an abnormality, the CPU 31 causes the display unit 37 to display information indicating that the transmission process has been ended due to the occurrence of an abnormality, as the third message. Therefore, according to the first exemplary embodiment, the user is caused to recognize that the transmission process has been ended due to the occurrence of an abnormality. In addition to the above information, information indicating the type of abnormality such as an error code maybe displayed on the display unit 37 as the information indicating that the transmission process has been ended due to the occurrence of an abnormality.

Second Exemplary Embodiment

Hereinafter, a second exemplary embodiment will be described while omitting or simplifying the repetitive portion of the other embodiments.

In the second exemplary embodiment, a cloud server 50 analyzes the log of a cloud service of a user, specifies a record in which edited data has been edited most recently, and transmits cloud service information (example: application name and record name) corresponding to the specified record to an image forming apparatus 20. A determination process in the second exemplary embodiment is executed in accordance with the flow of the first flowchart illustrated in FIG. 6 as in the first exemplary embodiment.

In the second exemplary embodiment, the cloud server 50 that has acquired user information transmitted from the image forming apparatus 20 in Step S10 illustrated in FIG. 6 acquires a log corresponding to the user information from the cloud service. The cloud server 50 analyzes the acquired log and specifies a record in which edited data has been edited most recently. In a case where there is a record in which the edited data has been edited most recently, the cloud server 50 acquires cloud service information (example: application name and record name) corresponding to the specified record from a storage unit 54, and then transmits the cloud service information to the image forming apparatus 20. In this case, in Step S11, the CPU 31 acquires the cloud service information and proceeds to Step S13. In a case where there is no record in which the edited data has been edited most recently, the cloud server 50 transmits information indicating that there is no corresponding cloud service information, to the image forming apparatus 20. In this case, since the CPU 31 does not acquire the cloud service information in Step S11, the process proceeds to Step S12.

In the second exemplary embodiment, by using the log of the cloud service, pre-setting before use becomes unnecessary, differing from the first exemplary embodiment in which the webhook is used.

Third Exemplary Embodiment

Hereinafter, a third exemplary embodiment will be described while omitting or simplifying the repetitive portion of the other embodiments.

In the third exemplary embodiment, a CPU 31 changes the display content of the screen in a case where a transmission screen 83 is displayed immediately after authentication of an image forming apparatus 20 of a user, and in a case where the transmission screen 83 is displayed via a record selection screen 81 immediately after the authentication of the image forming apparatus 20 of the user. Therefore, according to the third exemplary embodiment, it is possible to change the display content of the transmission screen 83 in accordance with a situation in which the transmission screen 83 is displayed.

Specifically, in the third exemplary embodiment, in a case where the transmission screen 83 is displayed immediately after the authentication of the image forming apparatus 20 of the user, the CPU 31 displays information for urging paying of an attention to a transmission destination of voucher data.

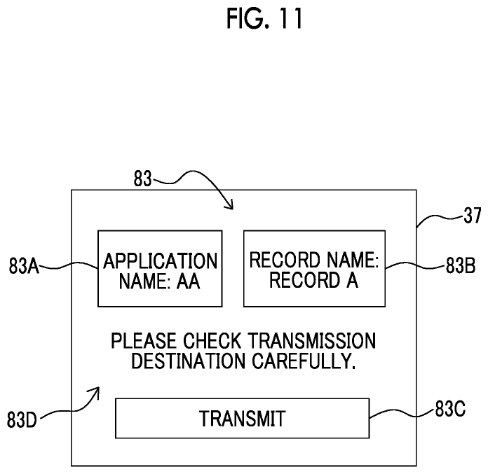

FIG. 11 illustrates a fourth display example of a display unit 37 of the image forming apparatus 20. Specifically, FIG. 11 illustrates a display example of the transmission screen 83 displayed immediately after the authentication of the image forming apparatus 20 of the user. Then, differing from the transmission screen 83 in the other exemplary embodiments, on the transmission screen 83 illustrated in FIG. 11, an attention display 83D being information for urging paying of an attention to a transmission destination of voucher data is displayed in addition to an application name display 83A, a record name display 83B, and a transmission button 83C. The attention display 83D shows a message for the user. As an example, the text “please check the transmission destination carefully” is displayed.

With the above configuration, according to the third exemplary embodiment, the user is caused to recognize information for urging paying of an attention to the transmission destination of the voucher data.

The attention display 83D is not limited to showing the message in text, but may show the message by a symbol such as an exclamation mark (!). In addition, as the changes in the above display contents, instead of or in addition to the display of the attention display 83D, the background color of the transmission screen 83, the color and dimensions of the text, display positions of the application name display 83A, the record name display 83B, and the transmission button 83C, and the like may be changed in accordance with the situation in which the transmission screen 83 is displayed.

Others

In the above exemplary embodiments, the edit screen 82 is displayed on the user terminal 70, but the present invention is not limited to this. The edit screen 82 may be displayed on the image forming apparatus 20. That is, in the information processing system 10, editing of edited data in the record is possible in the image forming apparatus 20 and the user terminal 70. However, considering that editing of the edited data in the record has difficulty in being performed due to the dimensions of the display unit 37 and the operability of the operation unit 38, and the occupancy of the image forming apparatus 20 for a long time is avoided, not the image forming apparatus 20 but the user terminal 70 may perform such editing.

In the above exemplary embodiments, the edited data is used as an example of the “input data”. Here, the edited data is the data of a record, which is displayed once on the edit screen 82. That is, the “edited data” includes data of a record in a case where the edit screen 82 is displayed, and then closed without an input of data in the item provided in the record, and data of a record in a case where pieces of data in some or all items provided in the record are input and then the edit screen 82 is closed.

In the above exemplary embodiments, the image forming apparatus 20 is used as an example of an “information processing apparatus”, but the present invention is not limited to this . The cloud server 50 may be used as an example of the “information processing apparatus”. In this case, the CPU 51 of the cloud server 50 serves as an example of the “processor”, and the “information processing program” is stored in the ROM 52 or the storage unit 54.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a first device capable of using a specific service succeeds in authenticating a user, and input data input by a function of the specific service selected by the user is present in a second device capable of using the specific service, display a screen provided in a case where the function is selected, without receiving the selection of the function by the user.

2. The information processing apparatus according to claim 1, wherein the processor is configured to:
display the screen after the authentication of the user.

3. The information processing apparatus according to claim 2, wherein the processor is configured to:
change the screen to be displayed after the authentication of the user, in accordance with the number of pieces of the input data present in the second device.

4. The information processing apparatus according to claim 3, wherein the processor is configured to:
in a case where there is one piece of the input data,
display a transmission screen for enabling transmission of relevant data related to the input data to the specific service.

5. The information processing apparatus according to claim 3, wherein the processor is configured to:
in a case where there are a plurality of pieces of the input data, display a selection screen for selecting the input data to which relevant data related to the input data is attached, and
after the input data is selected on the selection screen, display a transmission screen for enabling transmission of the relevant data to the specific service.

6. The information processing apparatus according to claim 4, wherein the processor is configured to:
in a case where there are a plurality of pieces of the input data, display a selection screen for selecting the input data to which relevant data related to the input data is attached, and after the input data is selected on the selection screen, display a transmission screen for enabling transmission of the relevant data to the specific service.

7. The information processing apparatus according to claim 4, wherein the processor is configured to:
in a case where the relevant data is transmitted to the specific service, change a display content of the screen in accordance with a processing time taken to execute a transmission process of the relevant data.

8. The information processing apparatus according to claim 5, wherein the processor is configured to:
in a case where the relevant data is transmitted to the specific service, change a display content of the screen in accordance with a processing time taken to execute a transmission process of the relevant data.

9. The information processing apparatus according to claim 6, wherein the processor is configured to:
in a case where the relevant data is transmitted to the specific service, change a display content of the screen in accordance with a processing time taken to execute a transmission process of the relevant data.

10. The information processing apparatus according to claim 7, wherein the processor is configured to:
in a case where the transmission process is normally ended without the processing time exceeding a predetermined time, display information indicating that the transmission process is normally ended.

11. The information processing apparatus according to claim 8, wherein the processor is configured to:
in a case where the transmission process is normally ended without the processing time exceeding a predetermined time, display information indicating that the transmission process is normally ended.

12. The information processing apparatus according to claim 9, wherein the processor is configured to:
in a case where the transmission process is normally ended without the processing time exceeding a predetermined time, display information indicating that the transmission process is normally ended.

13. The information processing apparatus according to claim 7, wherein the processor is configured to:
in a case where the transmission process is ended due to an occurrence of an abnormality without the processing time exceeding a predetermined time, display information indicating that the transmission process is ended due to the occurrence of the abnormality.

14. The information processing apparatus according to claim 8, wherein the processor is configured to:
in a case where the transmission process is ended due to an occurrence of an abnormality without the processing time exceeding a predetermined time, display information indicating that the transmission process is ended due to the occurrence of the abnormality.

15. The information processing apparatus according to claim 9, wherein the processor is configured to:
in a case where the transmission process is ended due to an occurrence of an abnormality without the processing time exceeding a predetermined time, display information indicating that the transmission process is ended due to the occurrence of the abnormality.

16. The information processing apparatus according to claim 7, wherein the processor is configured to:
in a case where the transmission process is not ended even though the processing time exceeds a predetermined time, display information indicating that a process result is presented after the end of the transmission process.

17. The information processing apparatus according to claim 1, wherein the processor is configured to:
change a display content of the screen in a case where a transmission screen for enabling transmission of relevant data related to the input data to the specific service is displayed after the authentication of the user, and in a case where the transmission screen is displayed via a selection screen for selecting the input data to which the relevant data is attached, after the authentication of the user.

18. The information processing apparatus according to claim 17, wherein the processor is configured to:
in a case where the transmission screen is displayed after the authentication of the user, display information for urging paying of an attention to a transmission destination of the relevant data.

19. A non-transitory computer readable medium storing an information processing program causing a computer to execute:
in a case where a first device capable of using a specific service succeeds in authenticating a user, and input data input by a function of the specific service selected by the user is in a second device capable of using the specific service, displaying a screen provided in a case where the function is selected, without receiving the selection of the function by the user.

20. An information processing method comprising:
in a case where a first device capable of using a specific service succeeds in authenticating a user, and input data input by a function of the specific service selected by the user is in a second device capable of using the specific service, displaying a screen provided in a case where the function is selected, without receiving the selection of the function by the user.
